(19) United States
(12) Patent Application Publication
(10) Pub. No.: US 2008/0210474 A1
(43) Pub. Date: Sep. 4, 2008

(54) Motor vehicle having a touch screen

(75) Inventors: Jackie Lai, Mountain View, CA (US); Zhaoxia Zhang, Sunnyvale, CA (US); Brian Finn, East Palo Alto, CA (US)

Correspondence Address: MANFRED BECK, P.A., 830 TYLER STREET, HOLLYWOOD, FL, 33019-1327, US

(73) Assignee: Volkswagen of America, Inc., Auburn Hills, MI (US)

(21) Appl. No.: 11/928,629

(22) Filed: Oct. 30, 2007

Related U.S. Application Data
(60) Provisional application No. 60/855,549, filed on Oct. 31, 2006.

(51) Int. Cl. G06F 3/041

(52) U.S. Cl. 178/18.03

(57) ABSTRACT

A motor vehicle includes a touch screen, which is disposed in the passenger compartment of the motor vehicle, for outputting a position signal. The position signal is dependent on the touch screen being touched. An actuator is provided for deflecting the touch screen. A control configuration evaluates the position signal for the purpose of recognizing a handwriting and for controlling the actuator in order to generate a haptic feedback for an operator of the touch screen.

### CROSS-REFERENCE TO RELATED APPLICATIONS

This application claims the benefit of the filing of U.S. Provisional Application No. 60/855,549, filed on Oct. 31, 2006, entitled “Input Device for a Motor Vehicle”, which is herewith incorporated by reference in its entirety.

### BACKGROUND OF THE INVENTION

### Field of the Invention

The invention relates to an input device, in particular for a motor vehicle, having a touch screen.

A touch screen is, for example, described in German Utility Model No. DE 201 02 197 U1. German Utility Model No. DE 201 02 197 U1 describes a touch screen for displaying electronic signals and a confirmatory touch input for characters and symbols composed of a functional level for displaying and make inputs by touch, and of a corresponding protection level which is located in a higher position and can be deformed at given points. In this context, when specific points of the functional level are chosen by making contact beyond the protection level, at least one confirmation signal for the sense of touch (haptic stimulation) of the user is generated so as to be perceptible at the position of the contact point in the deformed protection level, and the confirmation signal for the sense of touch (haptic stimulation) is generated via oscillation elements which are arranged eccentrically inside and/or below the functional level. In addition, in the case of the touch screen which is described in German Utility Model No. DE 201 02 197 U1, the oscillations which are generated are passed on from the functional level to the protection level by direct contact between the two levels and/or via the edge regions of the levels through the use of rigid or elastic connecting elements.

Touch screens are further disclosed, for example, by U.S. Pat. No. 4,885,565 and European Patent Specification No. EP 920 704 B1. Suitable touch screens can be obtained, for example, from 3M™ (see Internet address http://www.3m.com). Further details on touch screens can be obtained, for example, from European Patent Application Publication No. EP 1 560 102 A1 and corresponding U.S. Patent Application Publication No. 2005/0225539 A1.

German Utility Model No. DE 201 80 024 U1 and the corresponding International Application Publication No. WO 01/54109 A1 also disclose, for the purpose of providing haptic feedback, a touch-operated controller with haptic feedback for inputting signals into a computer and for outputting forces to a user of the touch-operated controller, the touch-operated controller having a touch-operated input device which has a substantially planar touch-sensitive surface which is operated in such a way that on the basis of a position on the touch-sensitive surface which a user touches a position signal is input into a processor of the computer, with the position signal representing the position in two dimensions. The touch-operated controller according to International Application Publication No. WO 01/54109 A1 also has at least one actuator which is connected to the touch-operated input device, with the actuator outputting a force to the touch-operated input device in order to supply a haptic sensation to the user who touches the touch-sensitive surface, with the actuator outputting the force directly to the touch-operated input device on the basis of force information which is output by the processor.

Haptic feedback is also known from U.S. Pat. No. 6,429,846, International Application Publication No. WO 03/038800 A1, U.S. Pat. No. 5,988,902, International Application Publication No. WO 99/26230 A1, International Application Publication No. WO 97/21160 A1, German Utility Model No. DE 200 22 244 U1 and corresponding U.S. Patent Application Publication No. US 2005/0219206 A1 and International Application Publication No. WO 03/41046 A1.

European Patent Application Publication No. EP 1 475 693 A2 discloses a combined display and input device of an information and/or communication system of a motor vehicle which is embodied as a touch-sensitive screen, with the touch-sensitive screen having at least two regions, specifically a first region in which operating elements can be represented graphically, wherein it is possible to activate a function of the information and/or communication system which is associated with the operating element by touching the graphically represented operating element, as well as a second region which is embodied as a handwriting input surface and which is connected to a handwriting recognition module, with the combined display and input device being designed to be installed permanently in the motor vehicle structurally separate from a control module of the display and input device.

German Patent Application Publication No. DE 103 49 673 A1 discloses an apparatus for inputting data in a motor vehicle, the apparatus having an input device for manually inputting data for controlling vehicle functions and/or additional devices, and having a head-up display which is connected thereto and has the purpose of displaying the input data in the field of vision of the driver, with the input device being provided with a touch-sensitive input panel (touch panel) for inputting data in the form of handwriting, and a handwriting recognition system for evaluating the input data, in which case the head-up display can be operated in a text mode in order to display the evaluated data in the form of text.

U.S. Provisional Application No. U.S. 60/754,993 and corresponding U.S. Patent Application Publication No. US 2007/0205625 A1 describe a motor vehicle, the motor vehicle including a flexible fabric which is arranged in a passenger compartment of the motor vehicle or a flexible material which is arranged in the passenger compartment of the motor vehicle and has the purpose of outputting an output signal which is dependent on a pressure which is applied to the flexible fabric or the flexible material, at least one electrical property of the flexible fabric or of the flexible material being variable as a function of the pressure which is applied to the flexible fabric or the flexible material, and the motor vehicle including a controller for evaluating the output signal for the purpose of recognizing text.

Further operating devices are known from U.S. Pat. No. 6,118,435, International Application Publication No. WO 01/19635 A2 and German Patent Application Publication No. DE 197 31 285 A1.

### SUMMARY OF THE INVENTION

It is an object of the invention is to improve an input device with a touch screen. It is in particular an object of the invention to provide an input device which is particularly well suited for motor vehicles. Accordingly, it is also an object of the invention to provide a motor vehicle with a touch screen.

With the foregoing and other objects in view there is provided, a motor vehicle, including:

a passenger compartment;

a touch screen disposed in the passenger compartment, the touch screen being configured to output a position signal which is dependent on the touch screen being touched;

an actuator operatively connected to the touch screen, the actuator being configured to deflect the touch screen; and

a control configuration operatively connected to the touch screen, the control configuration being configured to evaluate the position signal for the purpose of a handwriting recognition, the control configuration controlling the actuator in order to generate a haptic feedback for an operator of the touch screen.

In other words, the above-mentioned object is achieved by a motor vehicle including a touch screen, disposed in a passenger compartment of the motor vehicle, for outputting a position signal which is dependent on the touch screen being touched; an actuator for deflecting, i.e. moving, the touch screen, in particular in at least a direction which is substantially parallel to the operating surface and a control configuration for evaluating the position signal for the purpose of a handwriting recognition, and for controlling the actuator in order to generate a haptic feedback for an operator of the touch screen.

According to another feature of the invention, the touch screen is a transparent touch screen.

According to yet another feature of the invention, a display is disposed underneath the touch screen, and the display visually displays an input region assigned for a handwriting recognition.

According to a further feature of the invention, the input region has a boundary; and the control configuration is configured to generate a haptic feedback when the boundary of the input region is touched.

According to another feature of the invention, the control configuration converts a text, which has been recognized by a handwriting recognition, into an audible signal.

According to another feature of the invention, a loudspeaker is operatively connected to the control configuration for outputting the audible signal.

According to another feature of the invention, the control configuration is configured to convert text, which has been recognized by a handwriting recognition, into an image signal; and the display displays the image signal.

In accordance with an embodiment of the invention, a text in a language which uses an alphabet, a text in a language which uses a syllabary and/or a language which uses characters can be recognized by the handwriting recognition. The invention here is particularly well suited when it is used for inputting text in a language which uses characters. Suitable methods for recognizing handwriting can be found, for example, in U.S. Patent Application Publication No. 2004/0017946 A1, International Application Publication No. WO 99/57648, Japanese Patent Application Publication Nos. JP 05282499 A, JP 04184559 A, German Patent No. DE 41 19 091 C2, German Patent Application Publication No. DE 196 52 445 A1 and Japanese Patent Application Publication No. JP 06289983 A.

In accordance with a further embodiment of the invention, the touch screen is transparent. In accordance with another embodiment of the invention, the motor vehicle furthermore includes a display, which is disposed underneath the touch screen, for visually displaying an input region which is assigned to the handwriting recognition. In a further embodiment of the invention, a haptic feedback can be generated through the use of the control configuration when a boundary of the input region is touched.

In a further embodiment of the invention, a text which is recognized by the handwriting recognition can be converted into an audible signal through the use of the control configuration. In another embodiment of the invention, the motor vehicle further includes a loudspeaker for outputting the audible signal. In a further embodiment of the invention, the text, which is recognized by the handwriting recognition, can be converted through the use of the control configuration into an image signal which can be displayed through the use of the display.

With the above objects in view, there is also provided a motor vehicle, including:

a passenger compartment;

a touch screen disposed in the passenger compartment, the touch screen being configured to output a position signal which is dependent on the touch screen being touched;

a control configuration operatively connected to the touch screen, the control configuration being configured to evaluate the position signal for the purpose of a handwriting recognition;

the control configuration converting a text, which has been recognized by the handwriting recognition, into an audible signal; and

a loudspeaker, operatively connected to the control configuration, for outputting the audible signal.

In other words, the above mentioned object is additionally achieved by a motor vehicle, the motor vehicle including a touch screen, disposed in a passenger compartment of the motor vehicle, for outputting a position signal which is dependent on the touch screen being touched; a control configuration for evaluating the position signal for the purpose of recognizing a handwriting and for converting a text, which has been recognized by the handwriting recognition, into an audible signal, and a loudspeaker for outputting the audible signal.

In accordance with another embodiment of the invention, the text, which has been recognized by the handwriting recognition, can be converted through the use of the control configuration into an image signal. In accordance with a further embodiment of the invention, the motor vehicle also includes a display for displaying the image signal.

The above-mentioned object is additionally achieved by a vehicle, in particular one including one or more of the above-mentioned features, the motor vehicle including a touch screen disposed in a passenger compartment of the motor vehicle, for outputting an output signal which is dependent on the touch screen being touched, a control configuration for evaluating the output signal in the sense of recognition of handwriting, and for converting a text which has been recognized by the handwriting recognition into an image signal, and a display for displaying the image signal.

In accordance with another embodiment of the invention, the touch screen is transparent. In accordance with a further embodiment of the invention, the touch screen is disposed above the display or spatially separate from the display.

The motor vehicle in the sense of the invention is in particular a land motor vehicle which can be used individually in road traffic. Motor vehicles in accordance with the invention are in particular not restricted to land vehicles with internal combustion engines.

Other features which are considered as characteristic for the invention are set forth in the appended claims.

Although the invention is illustrated and described herein as embodied in a motor vehicle having a touch screen in its passenger compartment, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a partial diagrammatic perspective view of a passenger compartment of an exemplary embodiment of a motor vehicle according to the invention;

FIG. 2 is a schematic diagram of an exemplary embodiment of an input device according to the invention;

FIG. 3 is a diagrammatic perspective top view of the input device according to FIG. 2;

FIG. 4 is a diagrammatic sectional view of the input device according to FIG. 2;

FIG. 5 is a diagrammatic bottom plan view of the input device according to FIG. 2;

FIG. 6 is a diagrammatic front elevational view of the input device according to FIG. 2 during the display of an operating mask for inputting a destination for a navigation system in accordance with the invention;

FIG. 7 is a graph illustrating a deflection of a touch screen according to a type of deflection which is associated with an input confirmation; and

FIG. 8 is a graph illustrating a deflection of a touch screen according to a further type of deflection.

### DESCRIPTION OF THE PREFERRED EMBODIMENTS

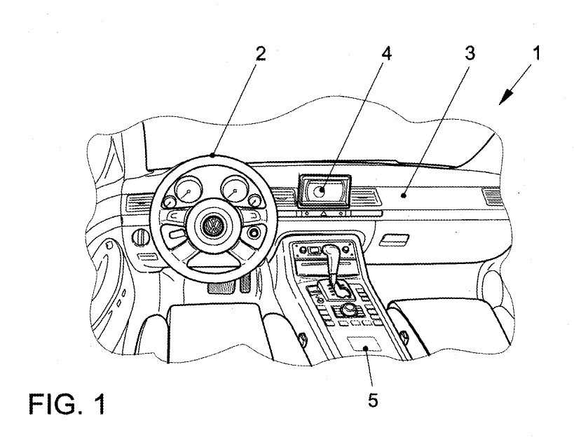

Referring now to the figures of the drawings and first, particularly, to FIG. 1 thereof, there is shown an exemplary embodiment of a passenger compartment of a motor vehicle 1. A steering wheel 2 is disposed in the passenger compartment underneath a dashboard 3. The dashboard 3 has an input device 4 which is disposed next to the steering wheel 2. Alternatively or additionally an input device which corresponds to the input device 4 can also be disposed in the steering wheel 2.

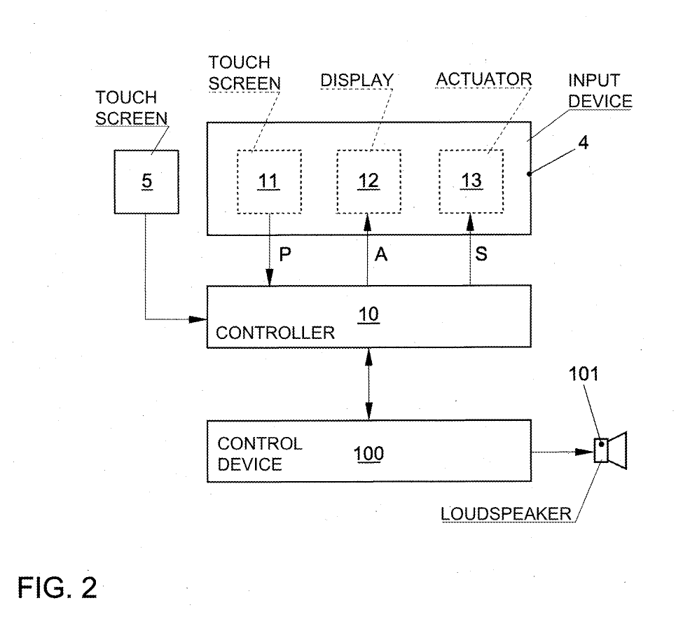

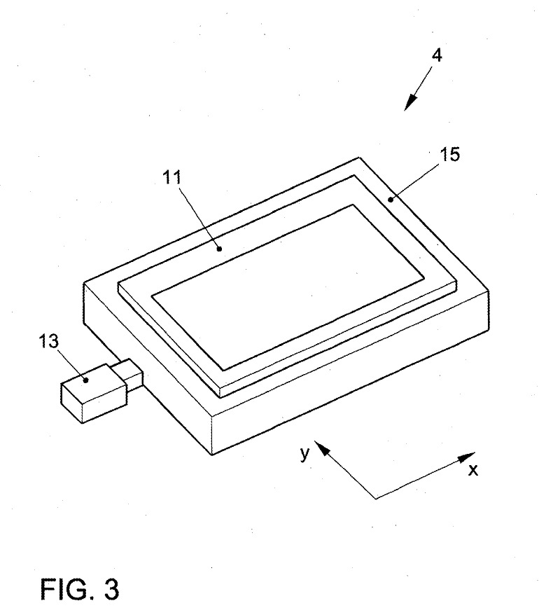

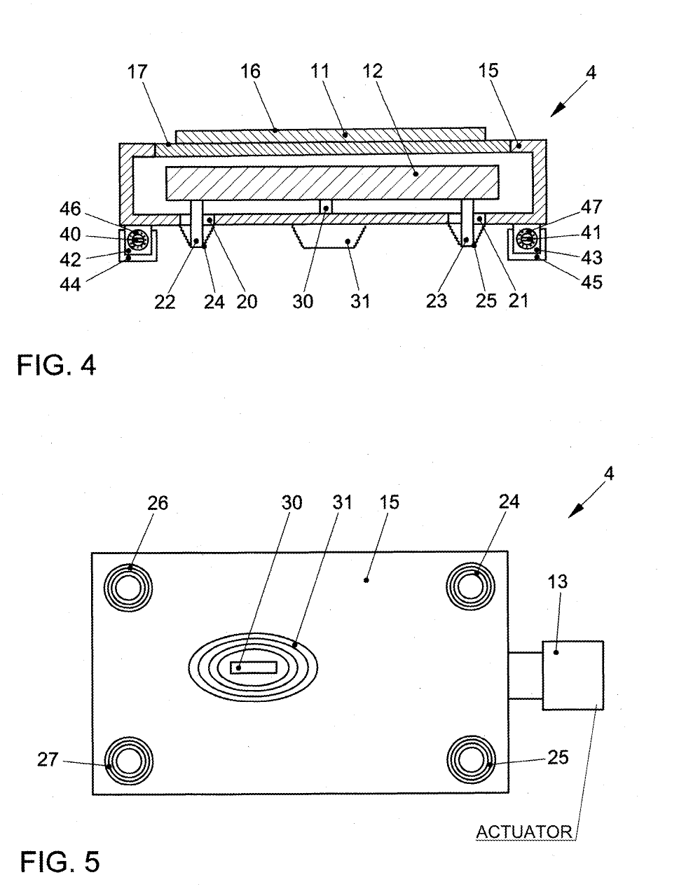

FIG. 2 shows a schematic diagram of the input device 4. FIG. 3 shows the input device 4 in a perspective top view. FIG. 4 shows the input device 4 in a cross section. FIG. 5 shows the input device 4 from below. The input device 4 includes a housing 15, a display 12 disposed in the housing 15, for visually displaying information, such as for example operating elements (operator control elements), for example for operating the motor vehicle 1, a touch screen 11 which is disposed above the display 12 and is connected to the housing 15 in order to detect when the touch screen 11 is touched and, respectively, in order to input commands by touching an operator control surface 16 of the touch screen 11, and an actuator 13 for moving the housing 15 and thus the touch screen 11 with respect to the display 12 in the x-direction, x and y designating the coordinates of an orthogonal coordinate system of a plane which is parallel to the operator control surface 16 of the touch screen 11. The input device 4 is assigned a controller 10 through the use of which different information can be displayed on the display 12 by outputting a corresponding display signal A. In addition, the controller 10 reads in a position signal P which has been output by the touch screen 11 and which indicates the position at which the operator control surface 16 was touched or at which pressure was applied to the operator control surface 16. In addition, the controller 10 controls the movement of the actuator 13 by outputting a control signal S. An embodiment of the actuator 13 can be found, for example, in European Patent Application Publication No. EP 1 560 102 A1. Furthermore piezo-actuators or what are referred to as voice coils can be used as the actuator 13. The controller 10 can also be integrated into the input device 4.

The touch screen 11 is attached to the outside of the housing 15. The housing 15 is transparent here at least in the region underneath the touch screen 11 which region is designated by the reference number 17. Alternatively, the touch screen 11 can also be embodied as part of the housing 15.

The housing 15 includes, as illustrated in FIGS. 4 and 5, four openings 20 and 21 which are each covered by a flexible collar 24, 25, 26 and 27 and through which attachment elements 22 and 23 for securing the display 12 to the steering wheel 2 or the dashboard 3 are guided. The housing 15 additionally includes a further opening which is covered by a further flexible collar 31 and through which a plug-in contact 30 for supplying power to the display 12 and for transmitting the display signal A to the display 12 is conducted. The flexible collars 24, 25, 26, 27 and 31 can be composed, for example, of an elastomer or include an elastomer. There is provision, in particular, for the flexibility of the collars 24, 25, 26, 27 and 31 to be matched to the mass of the housing 15, including the touch screen 11, in such a way that the housing 15 (including the touch screen 11) has, in conjunction with the collars 24, 25, 26, 27, and 31 a mechanical natural frequency between 5 Hz and 150 Hz. In this case, the natural frequency is matched in particular to the actuator 13, or the actuator 13 is selected in accordance with the natural frequency.

The input device 4 includes connecting elements for connecting the housing 15 to the display 12 in a form-locking (positively locking) manner so that the housing 15 can be moved with respect to the display 12 only along a straight line. For this purpose, a connecting element includes at least one attachment element 44 or 45, which is connected or can be connected to the steering wheel 2 or the dashboard 3 and has the purpose of securing in each case a rod 40 or 41. In addition, a connecting element includes in each case at least one sliding element 42 or 43 which is connected to the housing 15 and has in each case at least one sliding bearing 46 or 47 through the use of which the sliding element 42 or 43 can be moved along the rod 40 or 41. It is also possible to provide for the sliding element 42 or 43 to be connected or to be capable of being connected to the steering wheel 2 or the dashboard 3 and for the attachment element 44 or 45 to be (fixedly) connected to the housing 15. The movable connection between the display 12 and the housing 15 can be formed here via the steering wheel 2 or the dashboard 3 or via an additional element. In this context, it is possible, for example, for both the sliding elements 42 and 43 and the attachment elements 44 and 45 to be attached to a frame. This frame in turn can be connected to the steering wheel 2 or the dashboard 3 in order to install it in the motor vehicle 1.

In an alternative embodiment, the input device 4 includes a display as mentioned above, a touch screen, as mentioned above, which is disposed above the display, and a flexible element which is disposed between the display and the touch screen and has the purpose of preventing the ingress of particles between the display and the touch screen. Furthermore, the input device includes an actuator, as mentioned above, for moving the touch screen with respect to the display in at least one direction, in particular a direction which is parallel to the operator control surface of the touch screen. The flexible element is advantageously disposed here at the edge of the touch screen in such a way that it does not substantially cover a display surface or display area of the display. In accordance with an advantageous embodiment, the flexible element has a degree of rigidity which is matched to a mass of the touch screen in such a way that the touch screen has, in conjunction with the flexible element, a mechanical natural frequency between 5 Hz and 150 Hz in the direction of movement. In this context, the natural frequency is matched in particular to the actuator, or the actuator is selected in accordance with the natural frequency. The flexible element can be composed of a foamed material such as, for example, polyurethane or an elastomer. The flexible element can be embodied in accordance with U.S. Pat. No. 4,044,186 or the corresponding German Patent Application Publication No. DE 2 349 499 A1.

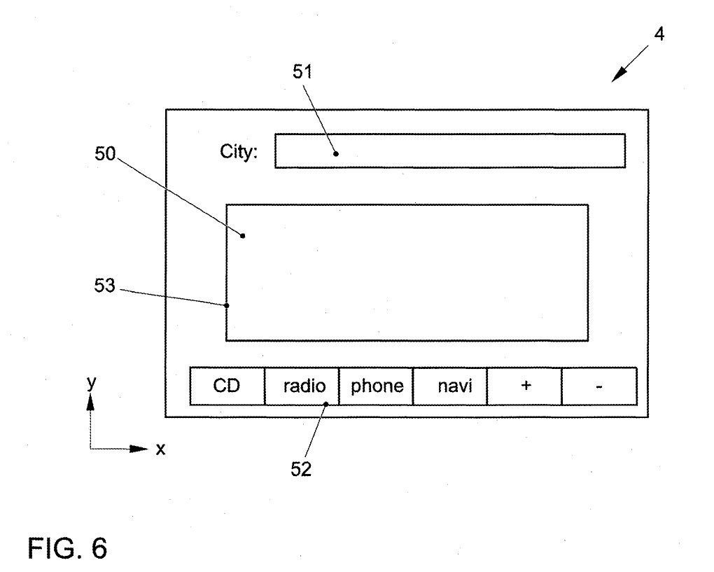

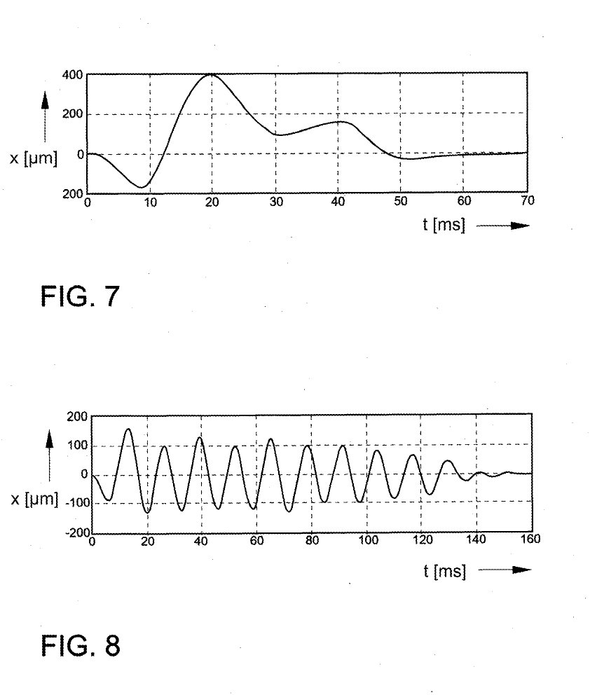

The controller 10 which is assigned to the input device 4 illustrated in FIG. 2 is connected in terms of data communication to a control device 100 for evaluating the position signal P or its temporal course (chronological profile) in the sense of recognizing handwriting. In this context it is possible to provide that not the entire touch screen 11 is provided for inputting handwriting but rather, as illustrated in FIG. 6, only an input region 50 which can be displayed by the display 12. In this context it is possible, for example, to provide that operating elements 52 are disposed in a region outside the input region 50. For example, it is thus possible, as illustrated in FIG. 6, to use the display 12 to form an operating element for calling a main menu for operating a CD (compact disk) player, an operating element for calling a main menu for operating a radio, an operating element for calling a main menu for operating a telephone and an operating element for calling a main menu for operating a navigation system. In this context it is possible to provide that when the touch screen 11 is touched in order to operate one of the operating elements 52, a haptic feedback, which is represented plotted against time t in FIG. 7, is generated with the actuator 13 as a deflection of the touch screen 11 in the x-direction in order to confirm a successful operation to an operator.

FIG. 6 shows the input device 4 during the representation of an operator control mask for inputting a destination for a navigation system, in which case a destination can be input in the form of handwriting into the input region 50. In this context there is provision that the actuator 13 is used to generate a haptic feedback in the form of a deflection of the touch screen 11 in the x-direction, as is illustrated in FIG. 8 plotted against time t, when a boundary 53 of the input region 50 is touched. If the destination is input in the form of handwriting within the input region 50, the name of the destination, which is recognized by the handwriting recognition function of the control device 100, is displayed in a display field 51. Furthermore, it is possible to provide for the name of the destination which is recognized by the handwriting recognition function of the control device 100 to be output audibly through the use of a loudspeaker 101 illustrated in FIG. 2.

In accordance with an embodiment of the invention, the motor vehicle 1 includes a further touch screen 5 which is embodied as a touch pad and which is connected in terms of data communication, in particular in a wireless fashion (for example via BLUETOOTH) to the control device 100 through the use of the controller 10 in such a way that handwritten inputs which have been made by touching the touch screen 5 can be identified by the handwriting recognition function implemented in the control device 100. If a destination is input in the form of handwriting on the touch screen 5, the name of the destination, which has been recognized by the handwriting recognition function of the control device 100, is displayed on the display 12. Furthermore, it is also possible to provide for the name of the destination which has been recognized by the handwriting recognition function of the control device 100 to be output audibly through the use of the loudspeaker 101. The controller 10 forms, in conjunction with the control device 100, an exemplary embodiment of a control configuration in accordance with the claims.

### LIST OF REFERENCE SYMBOLS

1 Motor vehicle
2 Steering wheel
3 Dashboard
4 Input device
5, 11 Touch screen
10 Controller
12 Display
13 Actuator
15 Housing
16 Operator control surface
17 Region
20, 21 Opening
22, 23 Attachment element
24, 25, 26, 27, 31 Collar
30 Plug-in contact
40, 41 Rod
42, 43 Sliding element
44, 45 Attachment element
46, 47 Sliding bearing
50 Input region
51 Display field
52 Operating element
53 Boundary of an input region
100 Control device
101 Loudspeaker
A Display signal
P Position signal
S Control signal
t Time
x, y Coordinate

What is claimed is:

1. A motor vehicle, comprising:
a passenger compartment;
a touch screen disposed in said passenger compartment, said touch screen being configured to output a position signal which is dependent on the touch screen being touched;
an actuator operatively connected to said touch screen, said actuator being configured to deflect said touch screen; and
a control configuration operatively connected to said touch screen, said control configuration being configured to evaluate the position signal for the purpose of a handwriting recognition, said control configuration controlling said actuator in order to generate a haptic feedback for an operator of said touch screen.

2. The motor vehicle according to claim 1, wherein said touch screen is a transparent touch screen.

3. The motor vehicle according to claim 2, further comprising a display disposed underneath said touch screen, said display visually displaying an input region assigned for a handwriting recognition.

4. The motor vehicle according to claim 3, wherein:
said input region has a boundary; and
said control configuration is configured to generate a haptic feedback when said boundary of said input region is touched.

5. The motor vehicle according to claim 1, wherein said control configuration converts a text, which has been recognized by a handwriting recognition, into an audible signal.

6. The motor vehicle according to claim 5, further comprising a loudspeaker, operatively connected to said control configuration, for outputting the audible signal.

7. The motor vehicle according to claim 3, wherein:
said control configuration is configured to convert text, which has been recognized by a handwriting recognition, into an image signal; and
said display displays the image signal.

8. A motor vehicle, comprising:
a passenger compartment;
a touch screen disposed in said passenger compartment, said touch screen being configured to output a position signal which is dependent on said touch screen being touched;
a control configuration operatively connected to said touch screen, said control configuration being configured to evaluate the position signal for the purpose of a handwriting recognition;
said control configuration converting a text, which has been recognized by the handwriting recognition, into an audible signal; and
a loudspeaker, operatively connected to said control configuration, for outputting the audible signal.

9. The motor vehicle according to claim 8, wherein said control configuration is configured to convert text, which has been recognized by a handwriting recognition, into an image signal.

10. The motor vehicle according to claim 9, further comprising a display, operatively connected to said control configuration, for displaying the image signal.
